(19) United States
(12) Patent Application Publication
(10) Pub. No.: US 2024/0069213 A1
(43) Pub. Date: Feb. 29, 2024

(54) CORRECTING OUTPUT OF GLOBAL SATELLITE NAVIGATION RECEIVER

(71) Applicant: EUROPEAN SPACE AGENCY (ESA), Paris (FR)

(72) Inventor: Gianluca CAPARRA, Noordwijk (NL)

(21) Appl. No.: 18/263,792

(22) PCT Filed: Feb. 2, 2021
(86) PCT No.: PCT/EP2021/052383

§ 371 Date: Aug. 1, 2023

(51) Int. Cl. G01S 19/40; G01S 19/07; G01S 19/39

(52) U.S. Cl. CPC G01S 19/40; G01S 19/07; G01S 19/396

(57) ABSTRACT

A system and method are provided for training a machine learnable model to correct an output of a global satellite navigation receiver (GNSS-R). The machine learnable model (ML-A) is trained to predict a positioning error based on a residual (RES) and satellite direction information (AZ, EL) which are provided during training, wherein the positioning error is a difference between a computed geolocation (PVT) and a reference geolocation (TP) provided during training. Furthermore, a system and method are provided for correcting an output of a global satellite navigation receiver. The machine learned model is used to predict the positioning error for the computed geolocation (PVT) based on the residual (RES) and the satellite direction information (AZ, EL) to obtain a predicted positioning error (EP), and the computed geolocation (PVT) is corrected to account for the predicted positioning error. The correction may take place in a device which comprises the global satellite navigation receiver.

### FIELD OF THE INVENTION

The invention relates to a training system and computer-implemented method of training a machine learnable model to correct an output of a global satellite navigation receiver. The invention further relates to a correction system and computer-implemented method of correcting an output of a global satellite navigation receiver using a machine learned model, and to a device comprising the correction system. The invention further relates to a computer-readable medium comprising data representing a computer program for performing a respective computer-implemented method, and to a computer-readable medium comprising data representing a machine learned model.

### BACKGROUND ART

Global Navigation Satellite System (GNSS) receivers are widely used to provide autonomous geo-spatial positioning. Advances in integration have resulted in such GNSS receivers being available as Integrated Circuits (ICs), for example as single-chip System-on-Chips (SoC). Their low cost and wide availability have resulted in ubiquitous adaption of GNSS receivers, not only in the professional domain but also in the consumer domain, e.g., in smart phones, tablet devices, cameras, etc. Examples of global navigation satellite systems include, but are not limited to, GPS, Galileo, GLONASS and BeiDou.

However, GNSS receivers are prone to positioning errors due to multipath propagation of satellites' radio signals, which phenomenon is also referred to as ‘multipath reception’ or ‘multipath signal’ from the perspective of the GNSS receiver. When a GNSS receiver tracks a multipath signal, e.g., by reflection of a transmitted radio signal by a close-by building, the GNSS receiver may estimate the distance to the transmitting satellite in an erroneous manner. This phenomenon is present particularly in urban environments, where Line-of-Sight (LoS) to satellites may be hindered and several of the radio signals received by a GNSS receiver may be multipath signals.

Several technical solutions have been investigated in order to mitigate the multipath problem, including design of radio signal that offer a better multipath rejection at the system level, as well as dedicated signal-processing techniques at the receiver side. The main drawbacks of these approaches may be an increase of the complexity, and hence the cost, of the GNSS receiver. For these reasons, mass-market receivers generally include limited multipath rejection at baseband processing, and rather apply some sort of filtering in the positioning engine. For instance, the use of Kalman filters is rather common, as it allows obtaining a smoother and more accurate trajectory.

It is also known to use machine-learning based techniques to address multipath problems and/or other causes of positioning errors in GNSS receivers.

US 2020/049837 describes a system and method for estimating device location. The system is said to include at least one processor configured to receive an estimated position based on a positioning system comprising a Global Navigation Satellite System (GNSS) satellite, and receive a set of parameters associated with the estimated position. The processor is further configured to apply the set of parameters and the estimated position to a machine learning model, the machine learning model having been trained based at least on a position of a receiving device relative to the GNSS satellite. The processor is further configured to provide the estimated position and an output of the machine learning model to a Kalman filter, and provide an estimated device location based on an output of the Kalman filter.

A problem of US 2020/049837 is that its machine learning model is applied to internal data of a GNSS receiver and not to its external output, e.g., the computed geolocation (referred to by US 2020/049837 as the ‘estimated device location’). Namely, the machine learning model is applied before Kalman filtering, with the Kalman filtering subsequently computing the geolocation based on the estimated position and the output of the machine learning model. In other words, the output of the machine learning model needs again to be used internally in the GNSS receiver.

Disadvantageously, US 2020/049837's proposed use of a machine learning model may require access to the internal operation of a GNSS receiver. This may be disadvantageous, e.g., if the integrity of a GNSS receiver is to be maintained, or if an existing hardware and/or software-based GNSS receiver is to be used. This may in turn limit the applicability of US 2020/049837's machine learned model.

### SUMMARY OF THE INVENTION

An object of the invention is to provide a machine learned model which may be used to correct an output of an GNSS receiver, and more specifically, to correct a geolocation as computed by the GNSS receiver during its operation.

A first aspect of the invention provides a computer-implemented method of training a machine learnable model to correct an output of a global satellite navigation receiver, as defined by claim 1. A further aspect of the invention provides a training system as defined by claim 13. A further aspect of the invention provides a computer-implemented method of correcting an output of a global satellite navigation receiver, as defined by claim 8. A further aspect of the invention provides a correction system as defined by claim 14. A further aspect of the invention provides a computer-readable medium comprising data representing a computer program, as defined by claim 11. A further aspect of the invention provides a computer-readable medium comprising data representing a machine learned model, as defined by claim 12.

In accordance with the above measures, a machine learnable model may be trained to correct an external output of a global satellite navigation receiver (elsewhere also referred to as GNSS receiver). The external output of such a GNSS receiver typically comprises a geolocation computed by the GNSS receiver, as well as auxiliary data which is also described elsewhere. The geolocation may for example be provided as a geographic coordinate in a geographic coordinate system, e.g., as a latitude and a longitude. The geolocation is typically of the receiver, but may in some embodiments correspond to a different geolocation, namely the geolocation at which radio signals from the GNSS satellites were received, e.g., in case the antenna(s) receiving the radio signals are provided separately from the GNSS receiver itself.

For the training of the machine learnable model, geolocation data may be obtained which may comprise multiple instances of geolocations computed by a GNSS receiver, with each instance representing a geolocation. For example, the geolocation data may represent a timeseries of data, e.g., a series of geolocations obtained over time from a stationary and/or moving GNSS receiver. Such geolocation data may also be obtained from several GNSS receivers, or may comprise different timeseries of geolocation data from one GNSS receiver, e.g., from different acquisition runs, etc.

In addition to the geolocation data, reference data may be obtained for the training, which reference data may comprise, for each or at least a number of geolocations from the geolocation data, a reference geolocation of the GNSS receiver. The reference geolocation may be considered as a ‘ground truth’ geolocation in that it may be considered to be, at least on average, more accurate than the computed geolocation by the GNSS receiver, and thus represent a ‘reference’ geolocation. In general, the reference geolocation may be obtained in separation of the GNSS receiver, e.g., using different means. For example, if the GNSS receiver is positioned at a stationary and known geolocation, such reference data may be generated manually. Likewise, if the GNSS receiver is moved with a known speed along a known trajectory during the acquisition of the geolocation data, the reference data may be generated algorithmically based on this known speed and known trajectory. In yet other examples, the reference data may be generated using a second GNSS receiver, e.g., a second GNSS receiver employing more elaborate multipath rejection at baseband processing. Yet another example to generate reference data for the training is to use a second GNSS receiver which may have an integrated inertial measurement unit (IMU), which in turn may allow the second GNSS receiver to more accurately determine a geolocation. Various other means of generating such reference data are conceived as well.

During or before the training, a positioning error may be determined using the geolocation data and the reference data, either on the fly or as a pre-processing step. The processing error may for example be obtained by simply subtracting the computed geolocation from the reference geolocation, or vice versa. In general, the positioning error may be determined as a correction term which, when applied to the computed geolocation, yields or at least approximates the reference geolocation.

In addition to the geolocation data and the reference data, auxiliary data may be obtained which may be generated by the GNSS receiver during its operation as auxiliary data to the geolocation data. Such auxiliary data may be included in the external output of a GNSS receiver, and may specifically include, for each one of one or more satellites used in determining the geolocation, a residual associated with a satellite as well as satellite direction information indicative of a direction of the satellite relative to the global satellite navigation receiver. Such a residual is known per se and may represent an error term resulting from a computational solution to the set of navigation equations. In a specific example, the residual may be a so-called range residual, also called pseudorange residual (also referred to as “posterior observation residual” or “measurement post-fit residual”), or an innovation residual obtained from a Kalman filtering performed by the global satellite navigation receiver. Effectively, the residual may indicate how much a measured parameter associated with a satellite, such as a measured range, deviates from the parameter computed in accordance with the computational solution to the set of navigation equations, i.e., the solution which corresponds to the computed geolocation. Intuitively, a higher residual may be understood as a measurement obtained from a particular satellite's radio signals, such as the pseudorange, being less reliable or less in agreement with the eventual geolocation computed by the GNSS receiver. With continued reference to the satellite direction information, the satellite direction information may be indicative of a direction of the satellite from the perspective of the global satellite navigation receiver. For example, the satellite direction information may comprise, for a respective satellite, an elevation and an azimuth of the satellite in the sky at the computed geolocation.

The machine learnable model may be trained to predict the positioning error from the auxiliary data, and more specifically, from the residual and the satellite direction information. Such training may effectively yield a form of adaptive ‘weighting filter’ which may weigh the residual and the satellite direction information to provide an estimate of the positioning error. Having trained the machine learnable model (which after training may also be referred to as a ‘machine learned model’), the machine learned model may be used to correct the output of a GNSS receiver during operation, and more specifically, to correct computed geolocations by applying the machine learned model to the auxiliary data to obtain a positioning error for the computed geolocations. The positioning error may then be used as a correction term for the computed geolocation, and may be applied to the computed geolocation to yield a corrected geolocation which may be more accurate than the originally computed geolocation. Here, ‘more accurate’ may refer to the geolocation deviating less from the actual geolocation, i.e., having a smaller positioning error to the actual geolocation.

The above measures are based on the insight that residuals and satellite direction information may be readily available as external output from a GNSS receiver, and may be indicative of the positioning error. Namely, the satellite direction information may be indicative of a direction of the satellite from the perspective of the GNSS receiver, which may be relevant for multipath reception since multipath reception is typically caused by objects in the receiver's environment which may affect radio signals received from certain directions more than others, while the residual may (in an inverse manner) represent a contribution of the satellite to the computed solution. This information together has been found to allow the positioning error to be estimated, as also demonstrated elsewhere in this specification, which positioning error may then be used as a correction term to correct the computed geolocation of the GNSS receiver. Compared to US 2020/049837, it is not needed to modify the GNSS receiver itself, e.g., by having to feed the output of the machine learned model back into the GNSS receiver. Rather, conventionally available external output of the GNSS receiver may be used in the form of the computed geolocation and, per satellite, residual and satellite direction information, to train the machine learnable model to estimate the positioning error. Advantageously, the performance of existing GNSS receivers may be improved, e.g., by applying the machine learned model as a software-based post-filtering, without a need to modify and thereby affect the integrity of existing GNSS receivers.

In an embodiment, the residual is one of:
a pseudorange residual; or
an innovation residual obtained from a Kalman filtering performed by the global satellite navigation receiver.

As indicated above, in some examples, the residual may be a so-called range residual, also called pseudorange residual (also referred to as “posterior observation residual” or “measurement post-fit residual”), or an innovation residual obtained from a Kalman filtering performed by the global satellite navigation receiver.

In an embodiment, the satellite direction information comprises, for a respective satellite, an elevation and an azimuth of the satellite in the sky at the computed geolocation. The elevation and azimuth may directly indicate the direction to the satellite from the perspective of the GNSS receiver. Advantageously, such elevation and azimuth data may be readily available as output from a GNSS receiver.

In an embodiment, the method comprises representing the elevation, the azimuth and the residual as a data tuple representing a spherical coordinate in a spherical coordinate system. The training data may comprise data tuples each formed by elevation, azimuth and residual, which in turn may be considered to represent a coordinate or vector in a spherical coordinate system. Namely, the elevation and azimuth may indicate the direction to the satellite, e.g., in degrees, while the residual may indicate the error in the pseudorange in the direction to the satellite, e.g., in meters, and thereby a magnitude towards the satellite or away from the satellite.

In an embodiment, the training method further comprises converting the spherical coordinate to a cartesian coordinate in an earth-centred, earth-fixed coordinate system, wherein the cartesian coordinate is used in the training of the machine learnable model. The residual and elevation/azimuth may represent quantities having different physical meaning, e.g., meters (residual) vs. degrees (elevation/azimuth). It may be beneficial for the training to obtain a representation of the residual, elevation and azimuth where the representation's data elements have a same physical meaning. Such a representation may be obtained by converting the residual and elevation/azimuth into a cartesian coordinate in an earth-centred, earth-fixed (ECEF) coordinate system, e.g., an XYZ coordinate system, in which case all elements may have a same physical meaning, e.g., meters, kilometres, etc. Other examples include the residual and elevation/azimuth being converted into a ‘local east, north, up’ (ENU) or ‘local north, east, down’ (NED) cartesian coordinate system.

In an embodiment, the training is further based on at least one of:
a carrier-to-noise ratio of a radio signal received from a satellite;
a quality indicator associated with the radio signal; and
a tracking indicator indicating presence and/or quality of signal tracking;
a multipath indicator indicating multipath reception;
an estimate of measurement noise;
an environment type indicating a type of environment at the geolocation of the global satellite navigation receiver; and
the geolocation, or a quantized version of the geolocation, of the global satellite navigation receiver.

GNSS receivers typically generate various types of quality- and reliability data and indicators as auxiliary data, such as the carrier-to-noise ratio, a tracking lock indicator, a multipath indicator, an estimate of the measurement noise, etc. Such types of data may be indicative of the magnitude and/or direction of the positioning error, and may be used as additional training data. In addition, or alternatively, an environment type may be used as additional training data, such as a label indicating whether the environment at the current geolocation is urban or rural. This may allow the machine learnable model to learn biases in the positioning error due to the environment type. In addition, or alternatively, the geolocation or a quantized version thereof may be used as additional training data, which may allow the machine learnable model to learn biases in the positioning error which are tied to a particular geolocation. By taking such additional data into account in the training, the machine learnable model may be trained to more accurately estimate the positioning error of the GNSS receiver.

It will be understood by the skilled person that some of these parameters, such as the residual and satellite direction information, are available per satellite, while other parameters are non-satellite specific, such as the environment type.

In an embodiment, the method further comprises determining the positioning error as a 2D positioning error or as a 3D positioning error. While the positioning error may typically be a 3D error, e.g., in longitude, latitude and height or in any other 3D geographic coordinate system, the machine learnable model may be trained to correct the positioning error only in 2D, e.g., only in longitude and latitude, as an improvement in accuracy in longitude and latitude may be sufficient in some applications. In other embodiments, the machine learnable model may be trained to correct the positioning error in 3D, e.g., in longitude, latitude and in height.

In an embodiment, the method may further comprise determining a velocity error, and training the machine learnable model to further predict the velocity error based on the auxiliary data. Such a velocity error may for example be obtained by determining a difference between the velocity computed by the GNSS receiver, which may for example be obtained from PVT data generated by the GNSS receiver, and a reference velocity, which reference velocity may be obtained in various known ways, for example using same or similar techniques as described elsewhere for obtaining the reference position, e.g., using a more accurate GNSS receiver or entirely separate means for measuring the velocity, e.g., based on beacons, etc. The resulting machine learned model may then be used to correct the computed velocity of a GNSS receiver in a same or similar manner as described elsewhere for correcting the computed position. In some embodiments, the entities described in this specification may train and use a machine learnable model to correct a velocity error without additionally (being trained for) correcting a positioning error. Such embodiments may correspond to embodiments described in this specification, where references to ‘position’ and ‘positioning error’ are to be read as ‘velocity’ and ‘velocity error’, mutatis mutandis.

In an embodiment of the correction method, said method may further comprise the training method, for example as a continuous learning step. The training method may thus be performed after deployment of the machine learned model, namely to perform (re)training of the model for the purpose of continuous learning. This may allow the accuracy of the machine learned model to be further improved after deployment, and may be helpful when insufficient ‘offline’ training data was available or when such training data was not fully realistic for the use case in which the machine learned model is used after deployment, e.g., for the type of GNSS receiver, the type of environment or the geolocation (e.g., latitude or longitude) in which it is used, etc.

In an embodiment, the correction method may further comprise obtaining a reference geolocation for the continuous learning step by at least one of:
enabling a user to manually enter a reference geolocation; and
sensing the reference geolocation in separation of the use of global satellite navigation, for example using a beacon.

While the geolocation data and the auxiliary data may be readily obtained after deployment from the GNSS receiver, e.g., as output data during its operation, the reference data may need to be obtained in separation of the GNSS receiver. The above-described options for obtaining reference data may be well-suitable, but it will be appreciated that various other options exist as well and may be advantageously used.

In an embodiment, a device may be provided comprising a global satellite navigation receiver and the correction system to correct an output of the global satellite navigation receiver. For example, the device may be a smart phone, tablet device, camera, laptop, smart watch, smart glasses, media player, media recorder, etc. Such a device may be able to more accurately determine its geolocation compared to a device without such a correction system.

In an embodiment, the device may comprise the training system as a continuous-learning subsystem. This may enable the device to continuously improve the accuracy of the computation of the geolocation by its GNSS receiver.

It will be appreciated that any embodiment of a system or device implies a corresponding embodiment of a corresponding method, and vice versa.

It will be appreciated by those skilled in the art that two or more of the above-mentioned embodiments, implementations, and/or aspects of the invention may be combined in any way deemed useful. Modifications and variations of any entity described in this specification, e.g., of any system, device, computer-implemented method, computer program or computer-readable medium, which correspond to the described modifications and variations of another one of these entities may be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows a GNSS receiver receiving radio signals from several satellites, with at least one of the radio signals being received as a multipath signal;

FIG. 2 shows an example of a general GNSS receiver architecture;

FIG. 3 shows a system architecture for a training phase for training a machine learnable model to correct an output of a GNSS receiver;

FIG. 4 shows a system architecture for a usage (correction) phase for using a machine learned model to correct an output of a GNSS receiver;

FIG. 5A shows a GNSS receiver receiving radio signals from satellites;

FIG. 5B shows a pseudorange and pseudorange residual for each of the radio signals received from the satellites;

FIG. 5C shows an error predicted by a machine learned model;

FIG. 5D shows a correction being applied to a GNSS-computed position;

FIG. 6 shows an example of a machine learnable model architecture;

FIG. 7 shows a training system for training a machine learnable model to correct an output of a GNSS receiver;

FIG. 8 shows a correction system for using a machine learned model to correct an output of a GNSS receiver;

FIG. 9 shows a dataset for testing;

FIG. 10A shows a probability density function of the 3D positioning error for uncorrected (initial) and corrected positional data;

FIG. 10B shows the average loss for training and validation epochs;

FIG. 11 shows a computer-readable medium comprising non-transitory data representing a computer program or a machine learned model.

It should be noted that items which have the same reference numbers in different figures, have the same structural features and the same functions, or are the same signals. Where the function and/or structure of such an item has been explained, there is no necessity for repeated explanation thereof in the detailed description.

### LIST OF REFERENCE AND ABBREVIATIONS

The following list of references and abbreviations is provided for facilitating the interpretation of the drawings and shall not be construed as limiting the claims.
ACQ acquisition
ACT activation layer
AZ azimuth
CNN convolutional neural network layer
COTS commercial off-the-self
CPE compute positioning error
CRP compute residual projections
DENSE dense layer
EL elevation
ERR-X predicted error in X-component
ERR-Y predicted error in Y-component
ERR-Z predicted error in Z-component
GNSS global navigation satellite system
GNSS-R GNSS receiver
ML machine learning
MLS ML system
MLM ML model
MLM-T ML model training
MPS multipath signal
NAV navigation
PE positioning error
P-ACT actual position
P-COM computed position
P-COR corrected position
PVT position, velocity, time
PSR pseudorange
PSR-R pseudorange residual
RES residual
RF radio frequency
RF-A RF antenna
RF-FE RF frontend
S(X) satellite (X)
TM trained model
TP true position
TRCK tracking
UD update
UE user equipment
100 training system
120 processor subsystem
140 input-output interface subsystem
150 data storage
200 correction system
220 processor subsystem
240 input-output interface subsystem
250 data storage
300 training data
310 machine learnable model
320 machine learned model
400 3D positioning error [m]
410 probability
450 initial
460 corrected
500 epoch
510 average loss
550 training
560 validation
600 computer-readable medium
610 data representing computer program, machine learned model

### DETAILED DESCRIPTION OF EMBODIMENTS

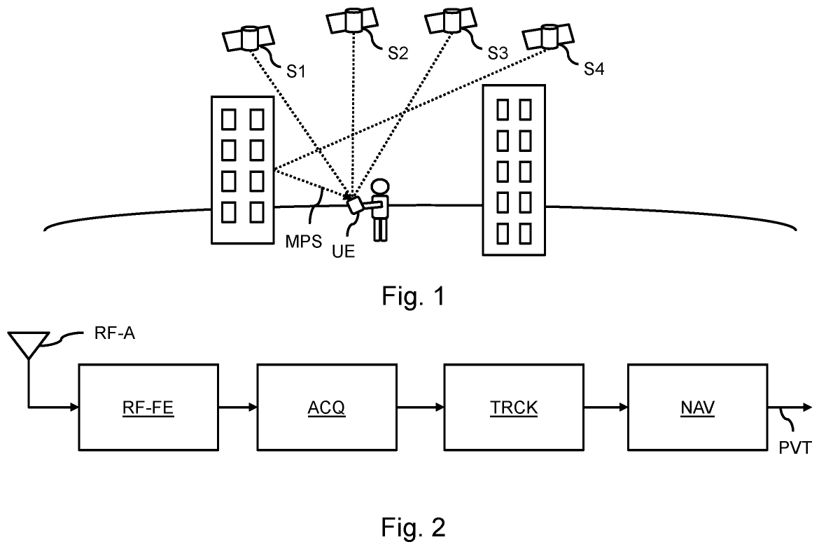

FIG. 1 schematically illustrates the operation of a global navigation satellite system (GNSS) receiver, which in the example of FIG. 1 is shown to be integrated into a device, the device being in the example of FIG. 1 an end-user device (also referred to as user equipment, UE). The GNSS receiver may be configured to receive radio signals from several satellites S1-S4 to compute its geolocation, for example by trilateration. Such global navigation satellite systems are known per se, and may for example include GPS, Galileo, GLONASS and BeiDou. In this respect, it noted that the geolocation is in the following also simply referred to as ‘position’, and vice versa.

FIG. 2 shows an example of a general GNSS receiver architecture, showing a radio-frequency (RF) antenna RF-A, a RF frontend RF-FE which may perform operations including but not limited to downconversion, filtering and sampling, an acquisition part ACQ which may perform acquisition in for example a serial or parallel manner, and a tracking part TRCK which may for example use frequency-locked loop (FLL), phase-locked loop (PLL) or delay-locked loop (DLL)-based tracking. Further shown is a navigation part NAV which may perform computations including but not limited to computing the satellites S1-S4 position’, pseudorange computation, position computation and least-square and/or Kalman filtering. The GNSS receiver's output may include so-called PVT data, referring to position (geolocation), velocity, time.

A GNSS receiver may in general compute an estimate of its position by measuring the distance to at least four satellites S1-S4. The radio signals from these satellites S1-S4 may contain information on the satellites' position and the transmission time, according to a system time. The GNSS receiver may register the reception time, according to its local reference clock, and may estimate the distance to a respective satellite by computing the propagation time. This distance estimate is usually referred to as ‘pseudorange’ as it may include the geometric range and errors from several sources, such as synchronization errors between the local reference clock and the system time, atmospheric effects, and errors introduced by multipath reception.

With continued reference to FIG. 1, such multipath reception may be briefly explained as follows. Due to the absence of line-of-sight between the GNSS receiver and the satellite S4, a radio signal transmitted by the satellite S4 may reach the GNSS receiver only after being reflected, for example by a building near by the GNSS receiver. A signal which is received via such reflection, or in general in an indirect manner, may also be referred to as a multipath signal since the signal does not reach the GNSS receiver by travelling via a direct (‘single’) path. As a result, the GNSS receiver may estimate the distance to the satellite S4 in an erroneous manner, which in turn may affect the computation of the geolocation. This phenomenon may in particular be present in urban environments, where the line-of-sight to satellites may be hindered and several of the radio signals may be received via multipath propagation.

The following measures may involve making use of information available from GNSS receivers, including commercially available GNSS receivers, to create a machine learned model to be used after the so-called positioning engine of a GNSS receiver, with the term ‘positioning engine’ referring to a function or part of the GNSS receiver computing the position, e.g., in form of PVT data. The machine learned model may be trained and subsequently used to infer positioning errors, which may then be used to correct the computed position so as to compensate for such positioning errors. As will also be explained elsewhere in this specification, during training, the regression or similar machine learning algorithm may effectively act as an adaptive weighting filter to be able to learn to predict positioning errors in different environmental conditions by learning to appropriately weight 3D components of the estimated positioning errors.

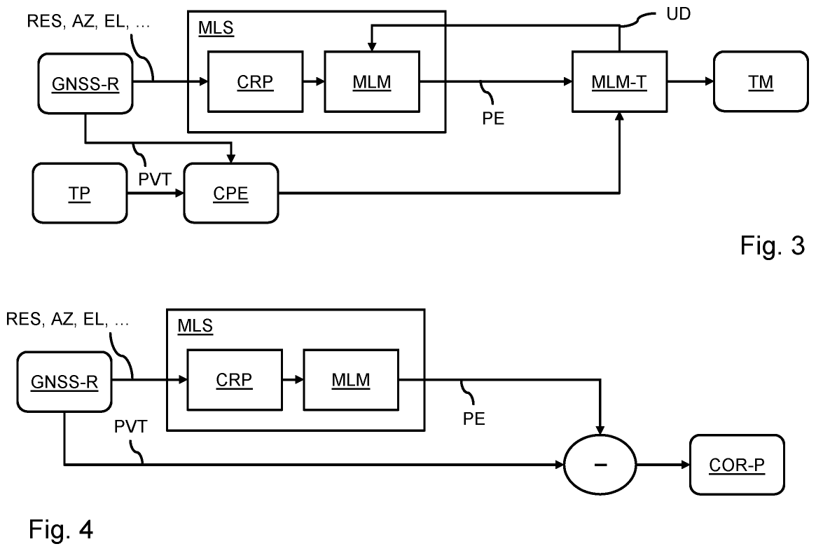

FIG. 3 shows a system architecture for a training phase for training a machine learnable model to correct an output of a GNSS receiver. Shown here is a GNSS receiver GNSS-R, which may be a known type of GNSS receiver, and which may generate PVT data during its operation. Such PVT data may be accessed during the training phase, as well as auxiliary data which may be generated by the GNSS receiver. Such auxiliary data may include, but not be limited to, a residual RES for each of the satellites of which its radio signal was used in the computation of the geolocation, as well as satellite direction information. Such satellite direction information may be indicative of direction towards a respective satellite from the perspective of the GNSS receiver, and may take various forms, including but not limited to data which directly specifies the direction, such as azimuth (AZ) and elevation (EL), or other data which allows the direction to be computed. An example of the latter is following: a GNSS receiver may internally compute a satellite position in a coordinate system (e.g., an earth-centred, earth-fixed coordinate system). Based this information and the computed geolocation, the direction to the satellite may be computed.

With continued reference to FIG. 3, during training, auxiliary data (RES, AZ, EL, . . . ) may be accessed, as well as computed geolocation data (e.g., from the PVT data) and reference data, which is in FIG. 3 obtained from a ‘true position’, TP, function. Such reference data may comprise, for each or at least a number of computed geolocations from the computed geolocation data, a reference geolocation representing a ‘true’ geolocation of the GNSS receiver. As described elsewhere, such a reference geolocation may be obtained in various ways, and may in general be considered to be more accurate than the computed geolocation from the GNSS receiver. Based on the computed geolocation data and the reference data, the positioning error may be computed by a ‘compute positioning error’, CPE, function. Such a computation may for example involve subtracting the computed geolocation from the reference geolocation, of vice versa, yielding a 2D or 3D computed positioning error which may then be used as learning goal in the training.

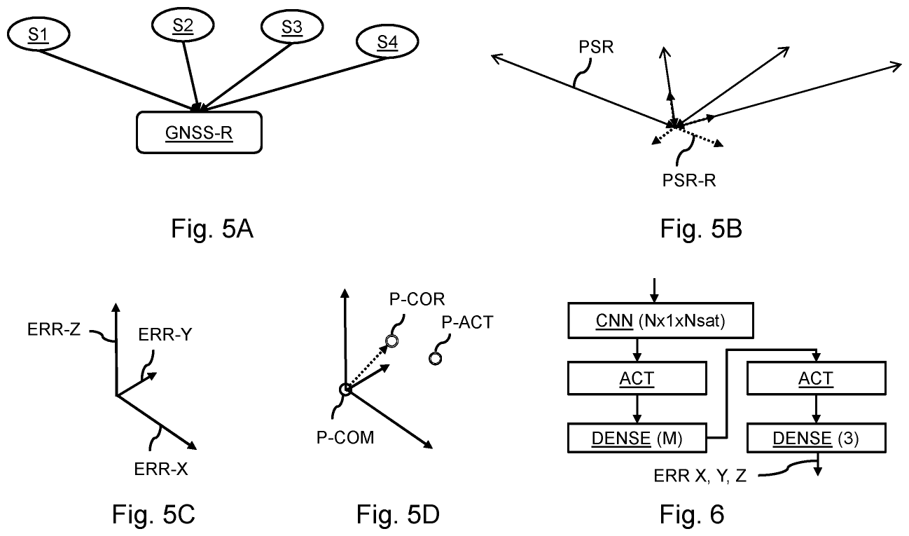

As further input to the training, a machine learning system MLS may compute so-called residual projections in a ‘compute residual projections’, CRP, function and may train a machine learnable model MLM based on the computed residual projections. The computation of the residual projections will also be explained with reference to FIGS. 5A-5D, but may in general involve transforming the auxiliary data into a coordinate or vector, or in general data tuple, for each of the satellites involved in the computation of the geolocation, which data tuple combines the residual associated with the satellite and the direction of the satellite as elements. For example, such a data tuple may be a coordinate in a spherical coordinate system in which the residual is the radial distance and the elevation EL and azimuth AZ represent the angles. In another example, as also explained with reference to FIGS. 5C and 5D, the data tuple may be a coordinate in an earth-centred, earth-fixed (ECEF) coordinate system, which is elsewhere, by way of example, an ‘XYZ’ coordinate system.

With continued reference to the CRP function, this function may be called projection as it may involve a coordinate transformation, e.g., from spherical coordinate system to an ECEF-based coordinate system, which coordinate transformation may be considered to involve a projection to the respective axes of the ECEF-based coordinate system. It will be appreciated, however, that the coordinate or vector may also be computed in any other manner, e.g., without involving such projections.

The training of the machine learnable model may involve a training MLM-T, which in turn may involve using known optimization algorithms and techniques to adjust parameters of the machine learnable model MLM, e.g., via updates UD by which weights or other model parameters may be adjusted. In the training, the computed positioning errors CPE may represent a learning goal, in that the machine learnable model MLM may be trained to infer a positioning error PE on the basis of the computed residual projections, which positioning error PE matches or approximates the computed positioning error CPE. Effectively, the ML model may be trained to predict the positioning error from several coordinates or vectors each representing a combination of residual and satellite direction. As a result of the training, a trained machine learnable model TM may be obtained, which may be exported, transmitted, stored, etc.

FIG. 4 shows a system architecture for a usage (correction) phase for using a machine learned model to correct an output of a GNSS receiver. Here, the machine learned model MLM, which may represent the trained model TM as described with reference to FIG. 3, may be used to correct geolocation data, such as PVT data, obtained from a GNSS receiver GNSS-R. For that purpose, a machine learned system MLS may obtain auxiliary data from the output of the GNSS receiver GNSS-R and may compute residual projections using a CRP function as described earlier with reference to FIG. 3. The computed residual projections may then be used as input to the trained machine learned model MLM, which may provide a positioning error EP as output which may be used to correct the geolocation, for example by adding or subtracting the positioning error EP to the position from the PVT data, thereby obtaining a corrected position COR-P. The corrected position may then be used in an application, such as for example navigation or measurement, instead of the originally computed position.

Essentially, the training phase may comprise training a machine learnable model to minimize a difference between positioning errors predicted by the model and those computed from reference data, e.g., a reference trajectory. The positioning error predicted by the ML model may then be subtracted from the (x, y, and z) components of the position provided by the GNSS receiver, increasing its accuracy.

FIGS. 5A-5D further illustrate the correction of a computed position from a GNSS receiver. In particular, FIG. 5A shows a GNSS receiver GNSS-R receiving radio signals from satellites S1-S4, with the relative position of the satellites with respect to the GNSS receiver being shown schematically, e.g., with satellite S2 being closer to the GNSS receiver than satellite S1. FIG. 5B shows a pseudorange PSR to each of the satellites, as computed by the GNSS receiver. The pseudorange PSR is shown as a vector having a length corresponding to the pseudorange and a direction corresponding to the direction of the satellite, as may be internally calculated by the GNSS receiver and indicated by auxiliary data which is output by the GNSS receiver. For each of the pseudorange coordinates/vectors, a pseudorange residual may be calculated, or said residual may already be contained in the auxiliary data. The pseudorange residual may be obtained by calculating a difference between a) the pseudorange as originally computed for a satellite, e.g., based on the received radio signals, and b) the pseudorange of the satellite in accordance with the geolocation as finally computed by the GNSS receiver. Such residual calculations are known per se. The residual may also be expressed as a coordinate or vector by taking into account the directional information, e.g., the elevation EL and azimuth AZ. Optionally, the resulting coordinate or vector may be converted into an ECEF coordinate system, e.g., yielding an X, Y and Z coordinate. The resulting residual coordinate or vector may then be used as input to the ML model, both during training and inference, to predict a positioning error. FIG. 5C shows such an error predicted by a machine learned model, being in this example a positioning error expressed in the XYZ coordinate system, e.g., having components ERR-X, ERR-Y and ERR-Z indicating the positioning error in the respective X, Y and Z directions. FIG. 5D shows a correction being applied to the computed position from the GNSS receiver, showing that the positioning error may be used to correct an originally computed position P-COM to obtain a corrected position P-COR which is nearer to the actual (‘true’) position P-ACT of the GNSS receiver.

It will be appreciated that the residual and the satellite direction information may also be formatted or converted into any other suitable format to serve training data for the machine learnable model. For example, the coordinate conversion into XYZ may be omitted, or a coordinate conversion into a different coordinate system may be used. The residual may be a pseudorange residual (also referred to as “posterior observation residual” or “measurement post-fit residual”), or an innovation residual obtained from a Kalman filtering performed by the GNSS receiver, or any other suitable type of residual used in or following from the calculation of the geolocation. The training and subsequent use of the ML model may be based on auxiliary data, e.g., residual and satellite direction information, of all the satellites of which the radio signals are taken into account in the computation of the geolocation. Alternatively, in some embodiments, a selection of the satellites may be made, meaning that the training may be based only on the auxiliary data of a subset of the satellites. Such a selection may for example be based on outlier filtering, e.g., by removing outliers of some sort from the training. Another example is that the training may be based on the auxiliary data of satellites having a sizable residual, e.g., the N-largest residuals or residuals exceeding a fixed or dynamic threshold. This may reduce the number of parameters in the ML model, thereby reducing the complexity of the training and/or of the ML model itself.

The training data may comprise other auxiliary data than the aforementioned types of auxiliary data, e.g., the residual and the satellite direction information. For example, quality and/or reliability indicators which may be computed internally by the GNSS receiver and which may be output by the GNSS receiver as auxiliary data may be used to complement the residual and the satellite direction information. Examples include, but are not limited to the carrier-to-noise ratio (C/N₀) of a satellite's radio signal, a quality indicator associated with the radio signal, a tracking lock indicator indicating presence of a tracking lock, a multipath indicator indicating multipath reception, an estimate of measurement noise, and an environment type indicating a type of environment at the geolocation of the global satellite navigation receiver. It will be understood by the skilled person that some of these parameters, such as the residual and satellite direction information, are available per satellite, while other parameters are non-satellite specific, such as the environment type. Any combination of such additional types of auxiliary data may be included in the training, e.g., as part of the training data, and may be input to the ML model during use.

With continued reference to the environment type, an environmental label indicating the environment type may be used as input during training and subsequent use, with the environmental label indicating or defining if the current or approximate geolocation is for example a rural or urban environment. Such environmental labels may for example be obtained from existing mapping data or geographical survey data.

In some embodiments, the geolocation itself, or a quantized version of the geolocation, of the global satellite navigation receiver, may be used as part of the training data. Since the geolocation is indicative of the type of environment, e.g., urban or not, the geolocation may be predictive of the presence of positioning errors and of the magnitude and/or direction of such positioning errors. Essentially, by taking (a quantized version of) the geolocation into account in the training, the ML model may be trained to learn how the radio signals statistically may reflect in a certain environment as a function of the azimuth and elevation of the satellite. For example, in when the GNSS receiver is positioned eastward of a block of high-rises, the positioning error may have a statistical bias in a particular direction, which direction may then be predicted by the ML model based on the geolocation or a quantized version thereof.

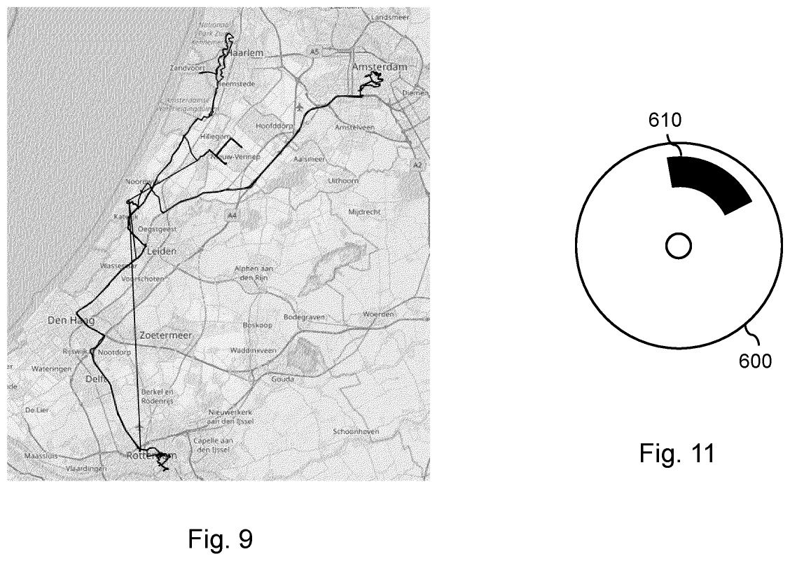

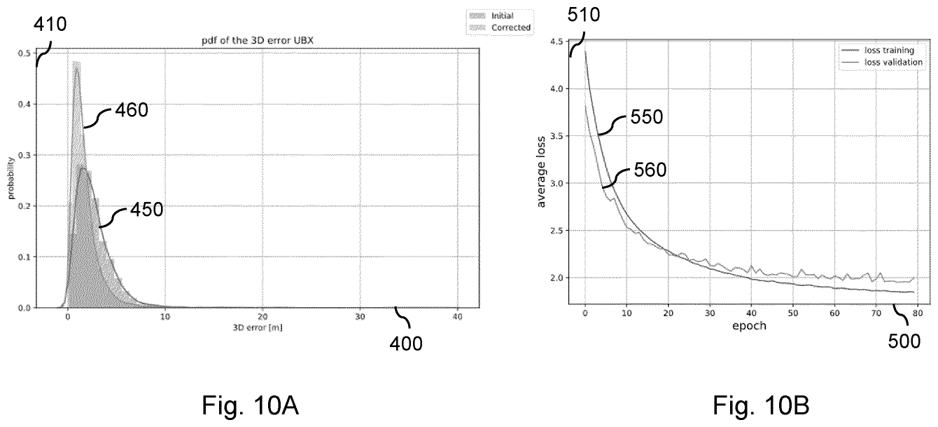

FIG. 6 shows an example of a machine learnable model architecture. In this example, the machine learnable model may comprise a convolutional neural network CNN having three layers, which is also described in the following in more detail and which performance is evaluated with reference to FIGS. 9-10B. It will be appreciated, however, that the machine learnable model may take various forms, including other types of CNN's (e.g., using different numbers and/or configurations of layers), other types of neural network, and other types of machine learnable models. In addition, the training of the machine learnable model may be performed in any suitable manner. For example, instead of using a supervised learning technique to train a (convolutional) neural network, a reinforcement learning (RL) technique may be used to, using a Markov decision process model, by a RL-agent to learn a policy which maximizes an expected cumulative reward. Here, the cumulative reward may be expressed as learning goal which causes the RL-agent to learn to select actions to correct the computed position based on the observation. The observation may in such a case comprise the residuals, the satellite direction information, and/or auxiliary data.

With continued reference to FIG. 6, the first layer may be a convolutional layer, with activation, to aggregate the 3D residuals from the same satellite, and from the same component (e.g., X, Y or Z). The middle layer may be a fully connected layer with activation. The third and last layer may be a fully connected layer with three neurons, without activation, which may provide the error estimation per component. Using a single ML model for all the three components simultaneously (multi target regression) may allow capturing the correlations among the components. In an even more specific example of the above, the first layer may be a convolutional layer with kernel size (1, 4) [4=3 directions+CN0], RELU activation, with 40 channels. The second layer may be a dense layer, N=64, with RELU activation. The third and last layer may be a dense layer, N=3, no activation. To obtain the performance measures described with reference to FIGS. 9-10B, the convolutional neural network was trained with ADAM optimizer and with a learning rate=0.002 and L2 regularization=0.001. The loss function was the L2 norm of the error on the positioning error predictions.

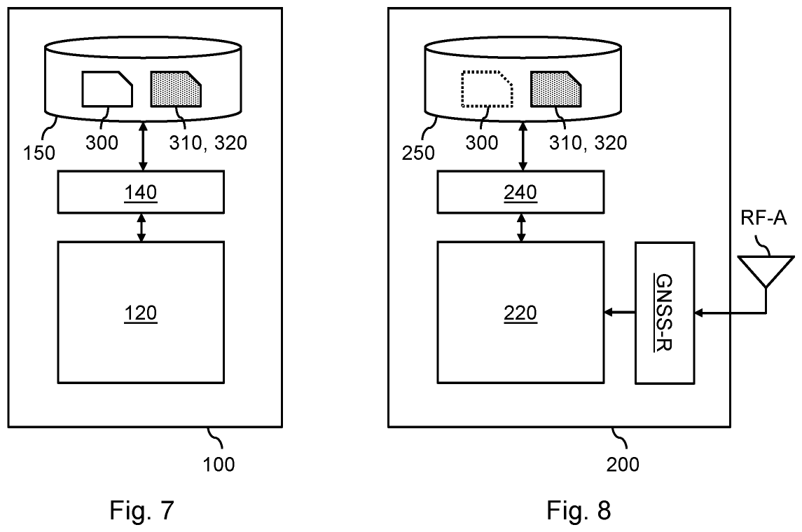

FIG. 7 shows a training system 100 for training a machine learnable model to correct an output of a GNSS receiver. The training system 100 may comprise an input interface subsystem for obtaining geolocation data, auxiliary data and reference data as described elsewhere in this specification, which together may also be referred to as training data. For example, as also shown in FIG. 7, the input interface subsystem may be a part of an input-output interface subsystem 140 providing data access to a data storage 150 which may comprise said training data 300. In general, the input interface subsystem may take various forms, such as a network interface to a local or wide area network, e.g., the Internet, a storage interface to an internal or external data storage, etc. The data storage 150 may take any known and suitable form, such as a hard disk, a solid-state disk, or a combination thereof. The data storage 150 is shown in FIG. 7 to comprise machine learnable model data 310 defining a machine learnable model. In some embodiments, the training data 300 and the machine learnable model data 310 may each be accessed from a different data storage. The training system 100 is further shown to comprise a processor subsystem 120 configured to train the machine learnable model in a manner as described elsewhere in this specification. The training system 100 may further comprise an output interface subsystem for outputting a data representation of a machine learned model representing a trained version of the machine learnable model. In the example of FIG. 7, the output interface subsystem may be part of the input-output interface subsystem 140, by which the processor subsystem 120 may store machine learned model data 320 of the trained model in the database 150, e.g., by overwriting the machine learnable model data 310 or separately. In other examples, the output interface subsystem may be separate from the input interface subsystem. In general, the output interface subsystem may take any suitable form or type, including those as described above for the input interface subsystem.

In general, the training system 100 may be embodied as, or in, a device or apparatus, such as a workstation, e.g., laptop or desktop-based, or a server. The device or apparatus may comprise one or more microprocessors which execute appropriate software. For example, the processor subsystem 120 may be embodied by a single Central Processing Unit (CPU), but also by a combination or system of such CPUs and/or other types of processing units, such as Graphics Processing Units (GPUs). The software may have been downloaded and/or stored in a corresponding memory, e.g., a volatile memory such as RAM or a non-volatile memory such as Flash. Alternatively, the functional units of the system, e.g., the input interface subsystem 140, the processor subsystem 120 and/or the output interface subsystem 140, may be implemented in the device or apparatus in the form of programmable logic, e.g., as a Field-Programmable Gate Array (FPGA). In general, each functional unit of the system may be implemented in the form of a circuit. It is noted that the system 100 may also be implemented in a distributed manner, e.g., involving different devices or apparatuses, such as distributed system of servers, e.g., in the form of so-called cloud computing.

FIG. 8 shows a correction system 200 for using a machine learned model to correct an output of a GNSS receiver. In the example of FIG. 8, the correction system 200 is shown to comprise the GNSS receiver GNSS-R as an internal component, with the GNSS receiver being connected to RF antenna RF-A (shown here as an external component, but which may also be an internal component). In other examples, the GNSS receiver may also be an external component but which may be in data communication with the correction system 200, e.g., via Bluetooth, Wi-Fi, Zigbee, etc. The correction system 200 may comprise an input interface subsystem, which may take any suitable form or type, including those as described with reference to FIG. 7 for the training system's input interface subsystem. By way of example, the correction system 200 is shown in FIG. 8 to comprise an input-output interface subsystem 240 to a data storage 250. The data storage 250 may take any known and suitable form, such as volatile or non-volatile memory, a solid-state disk, a hard drive, etc. The data storage 250 may comprise the machine learned model 320 generated by the training system 100 of FIG. 7. The correction system 200 may further comprise a processor subsystem 220 configured to use the machine learned model 320 to correct the output of the GNSS receiver in a manner as described elsewhere in this specification.

In some embodiments, the processor subsystem 220 may further be configured to train the machine learnable model. For that purpose, the data storage may comprise training data 300 and machine learnable model data 310 defining an untrained or at least partially trained machine learnable model. In some examples, the correction system 200 may be configured for so-called continuous learning, in which the machine learnable model may be retrained, for example periodically. In such cases, the training data 300 may comprise geolocation data and auxiliary data obtained from the GNSS receiver during operational use, and reference data obtained in separation of the GNSS receiver. For example, the reference data may be obtained by a user manually enter a reference geolocation, for example via a user interface (not shown in FIG. 8). Another example is that the correction system 200 may sense the reference geolocation in separation of the use of global satellite navigation, for example using a beacon, such as an NFC-based beacon. Such a beacon may for example be a static beacon, which may for example be included in roadside infrastructure, or may be a dynamic beacon, which may for example be included in a moving train, but for which dynamic beacon the current position may be determinable with high accuracy.

In general, the correction system 200 may be embodied as, or in, a device or apparatus, such as a mobile device, e.g., a smart phone, tablet device, camera, laptop, smart watch, smart glasses, media player, media recorder, etc. In some examples, the correction system 200 may be embodied as, or in, User Equipment (UE) of a mobile telecommunication network, such as a 5G or next-gen mobile network. In some examples, the correction system 200 may be embodied by a distributed system of devices, or may represent a virtual, software-based, client. In some examples, the correction system 200 may be embodied as, or in, a device or apparatus which may not be considered as a ‘mobile’ device but which nevertheless may be moved, e.g., by vehicle, to a position which may then need to be determined by use of GNSS.

The device or apparatus including the correction system 200 may comprise one or more microprocessors which execute appropriate software. For example, the processor subsystem 220 may be embodied by a single Central Processing Unit (CPU), but also by a combination or system of such CPUs and/or other types of processing units, such as Graphics Processing Units (GPUs). The software may have been downloaded and/or stored in a corresponding memory, e.g., a volatile memory such as RAM or a non-volatile memory such as Flash. Alternatively, the functional units of the system, e.g., the input interface subsystem 240, the processor subsystem 220 and/or the output interface subsystem 240, may be implemented in the device or apparatus in the form of programmable logic, e.g., as a Field-Programmable Gate Array (FPGA). In general, each functional unit of the system 200 may be implemented in the form of a circuit. It is noted that the system 200 may also be implemented in a distributed manner, e.g., involving different devices or apparatuses, such as distributed system of servers, e.g., in the form of so-called cloud computing.

FIG. 9 shows a dataset for evaluating the performance of a correction system incorporating a trained ML model as described in this specification. The dataset was used to evaluate the correction system correcting the output of an uBlox M8 GNSS receiver, being an example of a mass market, commercial off-the-shelf (COTS) GNSS receiver. The data collection was performed using the default settings, and with GPS, Galileo and GLONASS enabled. The reference trajectory was obtained by a Novatel SPAN system. The size of the dataset shown in FIG. 9 is around 117k points. The ML model was constructed and trained as previously described with reference to FIG. 6. Limited optimization of the neural network and of the training phase have been performed. The storage of the trained model parameters requires 256 kB.

FIG. 10A shows a probability density function of the 3D positioning error for an evaluation using the COTS GNSS' positioning engine. More specifically, FIG. 10A sets out along the horizontal axis 400 the 3D positioning error in meters and along the vertical axis the probability 410, while showing the probability density function (pdf) of the uncorrected (‘initial’) output 450 and corrected output 460 of the COTS positioning engine. It can be seen that the pdf of the 3D positioning error is generally narrower and closer to zero for the corrected output 460, showing that the ML model's correction of the positioning engine's output is effective in improving the positioning accuracy.

FIG. 10B shows the average loss 510 as a function of training and validation epochs 500 for the performance evaluation using the COTS positioning engine, showing the average loss during training with curve 550 and during validation with curve 560. These curves demonstrate the convergence of the training process.

It is noted that any of the methods described in this specification, for example in any of the claims, may be implemented on a computer as a computer implemented method, as dedicated hardware, or as a combination of both. Instructions for the computer, e.g., executable code, may be stored on a computer-readable medium 600 as for example shown in FIG. 11, e.g., in the form of a series 610 of machine-readable physical marks and/or as a series of elements having different electrical, e.g., magnetic, or optical properties or values. The executable code may be stored in a transitory or non-transitory manner. Examples of computer-readable mediums include memory devices, optical storage devices, integrated circuits, servers, online software, etc. FIG. 11 shows by way of example an optical storage device 600.

In an alternatively embodiment of the computer-readable medium 600, the computer-readable medium 600 may comprise data 610 representing a machine learnable or learned (‘trained’) model as described elsewhere in this specification.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A computer-implemented method of training a machine learnable model (MLM) to correct an output of a global satellite navigation receiver (GNSS-R), the method comprising:
obtaining geolocation data (PVT) which is generated by a global satellite navigation receiver, wherein an instance of the geolocation data represents a computed geolocation by the global satellite navigation receiver, wherein the computed geolocation is obtained by solving a set of navigation equations;
obtaining auxiliary data (RES, AZ, EL) which is generated by the global satellite navigation receiver in addition to the geolocation data, wherein an instance of the auxiliary data comprises, for a respective satellite:
a residual (RES) associated with the satellite, which residual is an error term resulting from a computational solution to the set of navigation equations;
satellite direction information (AZ, EL) indicative of a direction of the satellite relative to the global satellite navigation receiver;
obtaining reference data (TP) for the global satellite navigation receiver, wherein an instance of the reference data represents a reference geolocation of the global satellite navigation receiver;
training the machine learnable model (MLM) by:
for respective instances of the geolocation data and the reference data, determining a positioning error (CPE) as a difference between the computed geolocation and the reference geolocation;
in a training step, training the machine learnable model using the auxiliary data to predict the positioning error (PE) based on the residual and the satellite direction information;
outputting a data representation of a machine learned model (TM) representing a trained version of the machine learnable model.

2. The method according to claim 1, wherein the residual (RES) is one of:
a pseudorange residual; or
an innovation residual obtained from a Kalman filtering performed by the global satellite navigation receiver.

3. The method according to claim 1, wherein the satellite direction information comprises, for a respective satellite, an elevation (EL) and an azimuth (AZ) of the satellite in the sky at the computed geolocation.

4. The method according to claim 3, wherein the method comprises representing the elevation (EL), the azimuth (AZ) and the residual (RES) as a data tuple representing a spherical coordinate in a spherical coordinate system.

5. The method according to claim 4, further comprising converting the spherical coordinate to a cartesian coordinate in an earth-centred, earth-fixed coordinate system, wherein the cartesian coordinate is used in the training of the machine learnable model.

6. The method according to claim 1, wherein the training is further based on at least one of:
a carrier-to-noise ratio of a radio signal received from a satellite;
a quality indicator associated with the radio signal; and
a tracking indicator indicating presence and/or quality of signal tracking;
a multipath indicator indicating multipath reception;
an estimate of measurement noise;
an environment type indicating a type of environment at the geolocation of the global satellite navigation receiver; and
the geolocation, or a quantized version of the geolocation, of the global satellite navigation receiver.

7. The method according to claim 1, further comprising determining the positioning error as a 2D positioning error or as a 3D positioning error.

8. A computer-implemented method of correcting an output of a global satellite navigation receiver, the method comprising:
obtaining an instance of geolocation data (PVT) which is generated by a global satellite navigation receiver (GNSS-R), wherein the instance of the geolocation data represents a computed geolocation by the global satellite navigation receiver, wherein the computed geolocation is obtained by solving a set of navigation equations;
obtaining an instance of auxiliary data (RES, AZ, EL) which is generated by the global satellite navigation receiver in addition to the instance of geolocation data, wherein the instance of the auxiliary data comprises, for a respective satellite:
a residual (RES) associated with a satellite, which residual is an error term resulting from a computational solution to the set of navigation equations;
satellite direction information (AZ, EL) indicative of a direction of the satellite relative to the computed geolocation;
accessing a machine learned model (MLM) which is trained to predict a positioning error based on a residual and satellite direction information which are provided during training, wherein the positioning error is a difference between a computed geolocation and a reference geolocation provided during training;
using the machine learned model, predicting the positioning error (PE) for the computed geolocation based on the residual and the satellite direction information to obtain a predicted positioning error; and
correcting the computed geolocation to account for the predicted positioning error.

9. The method according to claim 8, further comprising the method as a continuous learning step.

10. The method according to claim 9, further comprising obtaining a reference geolocation for the continuous learning step by at least one of:
enabling a user to manually enter a reference geolocation; and
sensing the reference geolocation in separation of the use of global satellite navigation, for example using a beacon.

11. The A computer-readable medium comprising transitory or non-transitory data representing a computer program, the computer program comprising instructions for causing a processor system to perform the method according to claim 1.

12. The A computer-readable medium comprising transitory or non-transitory data representing a machine learned model obtainable by the method according to claim 1.

13. The A training system for training a machine learnable model to correct an output of a global satellite navigation receiver, the training system comprising:
an input interface subsystem for obtaining:
geolocation data which is generated by a global satellite navigation receiver, wherein an instance of the geolocation data represents a computed geolocation by the global satellite navigation receiver, wherein the computed geolocation is obtained by solving a set of navigation equations;
auxiliary data which is generated by the global satellite navigation receiver in addition to the geolocation data, wherein an instance of the auxiliary data comprises, for a respective satellite:
a residual associated with a satellite, which residual is an error term resulting from a computational solution to the set of navigation equations;
satellite direction information indicative of a direction of the satellite relative to the global satellite navigation receiver;
reference data for the global satellite navigation receiver, wherein an instance of the reference data represents a reference geolocation of the global satellite navigation receiver;
a processor subsystem configured to train the machine learnable model by:
for respective instances of the geolocation data and the reference data, determining a positioning error as a difference between a computed geolocation and a reference geolocation;
in a training step, training the machine learnable model using the auxiliary data to predict the positioning error based on the residual and the satellite direction information;
an output interface subsystem for outputting a data representation of a machine learned model representing a trained version of the machine learnable model.

14. The A correction system for correcting an output of a global satellite navigation receiver (GNSS-R), the correction system comprising:
an input interface subsystem for obtaining:
an instance of geolocation data which is generated by a global satellite navigation receiver, wherein the instance of the geolocation data represents a computed geolocation by the global satellite navigation receiver, wherein the computed geolocation is obtained by solving a set of navigation equations;
an instance of auxiliary data which is generated by the global satellite navigation receiver in addition to the instance of geolocation data, wherein the instance of the auxiliary data comprises, for a respective satellite:
a residual associated with a satellite, which residual is an error term resulting from a computational solution to the set of navigation equations;
satellite direction information indicative of a direction of the satellite relative to the computed geolocation;
a machine learned model which is trained to predict a positioning error based on a residual and satellite direction information which are provided during training, wherein the positioning error is a difference between a computed geolocation and a reference geolocation provided during training;
a processor subsystem configured to:
using the machine learned model, predict the positioning error for the computed geolocation based on the residual and the satellite direction information to obtain a predicted positioning error;
correct the computed geolocation to account for the predicted positioning error.

15. The A device (UE) comprising a global satellite navigation receiver (GNSS-R) and the correction system according to claim 14 to correct an output of the global satellite navigation receiver.

16. The device (UE) according to claim 15, further comprising the training system as a continuous-learning subsystem.
